(19) United States
(12) Patent Application Publication
(10) Pub. No.: US 2024/0099549 A1
(43) Pub. Date: Mar. 28, 2024

(54) CONVEYOR WAREWASHER AND METHOD FOR OPERATING A CONVEYOR WAREWASHER

(71) Applicant: ILLINOIS TOOL WORKS INC., Glenview, IL (US)

(72) Inventors: Harald DISCH, Elzach (DE); Martin SCHREMPP, Biberach (DE)

(21) Appl. No.: 18/475,357

(22) Filed: Sep. 27, 2023

(30) Foreign Application Priority Data
Sep. 28, 2022 (DE) 10 2022 125 000.8

(51) Int. Cl. A47L 15/42; A47L 15/00; A47L 15/24

(52) U.S. Cl. CPC A47L 15/4295; A47L 15/0026; A47L 15/0028; A47L 15/0034; A47L 15/0039; A47L 15/241; A47L 15/4208; A47L 15/4219; A47L 15/4225; A47L 2401/04; A47L 2501/01; A47L 2501/04; A47L 2501/06; A47L 2501/07; A47L 2501/10; A47L 2501/11; A47L 2501/12; A47L 2501/24; A47L 2501/26; A47L 2501/30; G06V 20/50

(57) ABSTRACT

A conveyor warewasher has at least one washing zone, at least one rinsing zone and a conveyor apparatus. A device for sensing a loading of the conveyor apparatus, which device is configured in order to determine, continuously or at predetermined or determinable times and/or events, a loading of the conveyor apparatus with washware. A control device is configured in order to, during a learning or observation phase over at least one observation period or over a plurality of observation periods each relating to a washing shift or a washing day of the conveyor warewasher or a portion thereof, determine a chronological profile of the loading of the conveyor apparatus with washware to be conveyed, wherein the control device is configured in order to deduce a pattern or a regularity based on the determined chronological profile of the loading of the conveyor apparatus with washware.

### TECHNICAL FIELD

The present invention relates generally to the field of commercial warewashing and, more particularly, to conveyor warewasher for cleaning washware, wherein the conveyor warewasher comprises at least one washing zone and at least one rinsing zone, as well as a conveyor apparatus for conveying the washware through the at least one washing zone and the at least one rinsing zone. The conveyor warewasher can, in particular, be designed as a belt conveyor warewasher or rack conveyor warewasher.

### BACKGROUND

In the case of conveyor warewashers, the washware, for example dishes, pots, glasses, cutlery, and other utensils to be cleaned, are conveyed through a plurality of treatment zones, for example through at least one pre-washing zone, at least one main washing zone, at least one post-washing zone or pre-rinsing zone, at least one fresh water rinsing zone, and at least one drying zone. However, different types of washware require different treatment parameters for the individual process steps due to their application, their degree of soiling, their shape, and the material used. In today's conveyor warewashers, there is usually no automatic differentiation of the types of washware, so that the conventional systems are often designed as a compromise in order to be usable for several different types of washware.

However, a conveyor warewasher is known, for example, from DE 10 2020 128 333 A1, which has a certain “intelligence”, since the conveyor warewasher known from this prior art comprises a device for the automatic detection and recognition of washware types.

On the other hand, a conveyor warewasher is known, for example, from DE 10 2008 037 344 A1, which comprises a washware sensor device for detecting empty compartments of the conveyor apparatus, which comprises a plurality of compartments.

The problem with the approaches known from the state of the art is that a conveyor warewasher is typically operated continuously during a washing shift, for example during a washing day. The washing personnel loads the conveyor apparatus of the conveyor warewasher with the washware that is currently arising in the washing kitchen. Since the amount of washware per time unit varies greatly over a washing shift or washing day, it is often impossible to avoid operating the conveyor warewasher with only a partial load.

Although it is generally known, for example from the already mentioned publication DE 10 2008 037 344 A1, to detect empty compartments of the conveyor apparatus, this is not suitable for the operation of the conveyor warewasher in order to guarantee the most efficient operation of the conveyor warewasher over a longer period of time. In the aforementioned prior art, it is provided that, depending on the detection of empty compartments, the rinsing liquid sprayed per time unit in the at least one rinsing zone is adjusted. This can save resources (energy, water, and chemicals) in individual cases, but over a longer period of time, automatic setting of the amount of rinsing liquid sprayed per time unit in the at least one rinsing zone is not suitable for efficiently optimizing the operation of the conveyor warewasher.

### SUMMARY

Based on this problem, the present invention is thus based on the task of further designing a conveyor warewasher of the type mentioned above so that it can be operated as efficiently as possible despite continuous operation during a washing shift. Furthermore, a corresponding method of operating such a conveyor warewasher is to be specified.

Accordingly, the present invention relates in particular to a conveyor warewasher for cleaning washware, wherein the conveyor warewasher comprises at least one washing zone and at least one rinsing zone, and a conveyor apparatus for transporting washware through the at least one washing zone and at least one rinsing zone. The conveyor warewasher according to the invention furthermore comprises a device for sensing the load of the conveyor apparatus. This device for sensing the load of the conveyor apparatus is designed to determine, preferably continuously or at predetermined times and/or events, a load of the conveyor apparatus with the washware that is to be transported through the treatment zones of the conveyor warewasher.

According to the invention, it is provided in particular that the conveyor warewasher comprises a control device which is designed to determine, in particular during a learning or observation phase, over at least one observation period and preferably over a plurality of observation periods, which in each case preferably relate to a rinsing shift or rinsing day of the conveyor warewasher or a time period thereof, a temporal development of the load of the conveyor apparatus with washware to be transported through the treatment zones of the conveyor warewasher. Herein the control device is preferably furthermore designed to derive a pattern or regularity based on the determined temporal development of the load of the conveyor apparatus.

Accordingly, the conveyor warewasher according to the invention has a certain “intelligence”, since artificial knowledge is generated from experience with the help of the control device or with the help of the device for capturing a load of the conveyor apparatus. The control device learns from examples during the learning or observation phase, and can generalize them after the learning phase has been completed. To this end, algorithms of the control device in machine learning build a statistical model that is based on training data that was generated in particular during the learning or observation phase. These training data are preferably continuously tested against new data (test data) after the end of the learning or observation phase. In other words, the control device of the conveyor warewasher according to the invention does not simply memorize the examples gained during the learning or observation phase, but preferably recognizes patterns and regularities in the learning data.

After a certain learning procedure during the learning or observation phase, this allows the conveyor warewasher according to the invention to be optimally adapted or adaptable to the respective application. In particular, the control device is designed to continuously analyze the washing/rinsing behavior of the washing personnel or the operator of the conveyor warewasher assigned to the conveyor warewasher in order to either automatically adjust process parameters of the conveyor warewasher in response, or to provide recommendations to the washing personnel or the operator of the conveyor warewasher for the most efficient operation of the conveyor warewasher.

According to an implementation of the conveyor warewasher according to the invention, it is thereby provided that the control device is furthermore designed to divide the observation period, which—as already mentioned—preferably relates to a rinsing shift or rinsing day of the conveyor warewasher or a period of time thereof, into a first sub-period and into at least one further, second sub-period. In the first sub-period of the observation period, the determined, in particular average, load level of the conveyor apparatus corresponds to a first relative value or falls within a first relative value range. In contrast, in the at least one second sub-period of the observation period, the determined, in particular average, load level of the conveyor apparatus corresponds to a second relative value or falls within a second relative value range.

For example, it is conceivable that the first relative value of the in particular average load level of the conveyor apparatus corresponds to a remaining loading capacity of the conveyor apparatus that is greater than the remaining loading capacity of the conveyor apparatus which corresponds to the second relative value of the in particular average load level of the conveyor apparatus.

Furthermore, it is conceivable, for example, that the first sub-period corresponds to a time period in the morning, as there is generally only a small amount of washware to be cleaned with the conveyor warewasher in the morning. The second sub-period may, for example, correspond to a time period around midday in which significantly more washware is produced, according to experience.

Of course, other time slots for the first and the at least one other, second sub-period are also possible.

Particularly preferable is provided that the control means is further designed, especially after the end of the learning or observation phase, preferably automatically and more preferably automatically during operation of the conveyor warewasher during a washing shift or during a washing day for the first sub-period, to initiate at least one first measure influencing the treatment of the washware in the treatment zones of the conveyor warewasher and/or at least one measure influencing the quality of the liquid to be sprayed in the at least one washing zone of the conveyor warewasher, if necessary with a delay. Likewise, it is conceivable that the control device is furthermore designed to initiate, for the at least one second sub-period, at least one second measure influencing the treatment of the washed goods in the treatment zones of the conveyor warewasher and/or at least one second measure to be influencing the quality of a washing liquid to be sprayed in the at least one washing zone of the conveyor warewasher, if necessary with a delay.

In other words, in this design variant, the conveyor warewasher according to the invention has some intelligence, as the control device associated with the conveyor warewasher “knows” from the previously determined learning data at which periods during a washing day or washing shift of the conveyor warewasher a large amount of washware is produced. With this knowledge, the conveyor warewasher can adjust the treatment parameters of the conveyor warewasher accordingly in advance, or adjust the quality of the washing liquid to be sprayed in the at least one washing zone of the conveyor warewasher.

For example, the measure influencing the treatment of the washware in the treatment zones of the conveyor warewasher consist of at least one of the measures listed below:
Increasing or decreasing the temperature of the rinsing liquid to be sprayed in the at least one rinsing zone; and/or
Increasing or decreasing the pressure of the rinsing liquid to be sprayed in the at least one rinsing zone; and/or
Increasing or decreasing the amount of rinsing liquid sprayed per time unit in the at least one rinsing zone; and/or
Increasing or decreasing the temperature of the washing liquid to be sprayed in the at least one washing zone; and/or
Increasing or decreasing the pressure of the washing liquid to be sprayed in the at least one washing zone; and/or
Increasing or decreasing the amount of washing liquid sprayed per time unit in the at least one washing zone; and/or
Increasing or decreasing the pressure of drying air to be sprayed in an optional drying zone; and/or
Increasing or decreasing the temperature of drying air to be sprayed in an optional drying zone; and/or
Increasing or decreasing the amount of drying air sprayed per time unit in an optional drying zone; and/or
Increasing or decreasing the conveying speed of the conveyor apparatus.

It is therefore conceivable, for example, that during a period of time in which only a low load of the conveyor apparatus occurs or is expected, the control device automatically reduces the transport speed of the conveyor apparatus. In this manner, the contact times of the washware in the treatment zones of the conveyor warewasher are increased. This, in turn, allows the temperature and/or mechanics and/or the amounts of liquid to be sprayed per time unit in the respective treatment zones to be reduced without having a negative impact on the washing or rinsing result. However, these measures can significantly conserve resources during the operation of the conveyor warewasher.

As already stated, it is conceivable that the control device can also adjust the quality of the washing liquid to be sprayed in the at least one washing zone of the conveyor warewasher, depending on the selected sub-period. It is conceivable in this context that the measure influencing the quality of the washing liquid to be sprayed in the at least one washing zone of the conveyor warewasher consists of at least one of the measures listed below:
Increasing or decreasing a regeneration of the washing liquid to be sprayed in the at least one washing zone of the conveyor warewasher;
Increasing or decreasing a dirt-carrying capacity of the washing liquid to be sprayed in the at least one washing zone; and/or
Activating or deactivating a dirt discharge from the washing liquid to be sprayed in the at least one washing zone.

The regeneration of the washing liquid occurs during the washing or rinsing process through the water supply inlet, mostly from the fresh water clear rinse, as viewed in the transport direction of the washware.

In commercial washing, the term “dirt-carrying capacity” refers to the ability of a cleaning agent solution, for example the ability of the washing liquid to be sprayed in the at least one washing zone, to disperse or emulsify food residues in such a manner that they cannot settle back onto cleaned washware surfaces. The dirt-carrying capacity can, in particular, be adjusted with the concentration of the chemical cleaning agent in the cleaning solution.

On the other hand, the dirt load of the cleaning solution or washing liquid affects the cleaning result as well as foam formation. The dirt load of the washing liquid is the entirety of all dirt components, regardless of whether they are easily or poorly soluble, emulsifying, and/or dispersible contaminants of the cleaning solution or washing liquid.

In particular, the dirt load of the washing liquid can be affected by dirt discharge.

Accordingly, the conveyor warewasher according to the invention, according to further developments of the last-mentioned aspect, comprises a device for preferably automated dirt discharge from the washing liquid to be sprayed in the at least one washing zone.

According to implementations of this dirt discharge device, it is provided that the at least one washing zone of the conveyor warewasher comprises a washing system that is designed as a recirculation circuit, wherein the washing system comprises a nozzle system with at least one washing nozzle for spraying washing liquid onto the washware to be cleaned, a washing tank for collecting at least a part of the sprayed washing liquid, and a washing pump for supplying washing liquid collected in the washing tank to the at least one washing nozzle.

Furthermore, a dirt discharge system that is associated with the at least one washing system is provided. A tank cover screen is associated with the dirt discharge system, and is designed to separate particles of dirt from the washing fluid that flows back into the washing tank by gravity. The dirt discharge system furthermore comprises a dirt collection area that is arranged at least partly within the washing tank, and serves to collect dirt particles separated from the washing liquid by means of the tank cover screen.

Furthermore, a dirt discharge system fluidly connected to the dirt collection area and comprising a dirt discharge pipe system is provided, via which the dirt collection area of the dishwasher can be emptied; in particular, as needed.

In this embodiment of the conveyor warewasher according to the invention, the control device is designed in particular to activate and/or deactivate, preferably automatically and even more preferably optionally automatically, as a function of the determined, in particular average, load level of the conveyor apparatus and, if appropriate, with a time delay, the dirt discharge system; and, in particular, a dirt discharge pump that is associated with the dirt discharge system, in order to activate or deactivate a dirt discharge from the washing liquid to be sprayed in the at least one washing zone, which positively influences the quality of the washing liquid to be sprayed in the at least one washing zone of the conveyor warewasher.

According to particularly easily implemented but nonetheless effective solutions, the device for detecting a load of the conveyor warewasher comprises a camera system which is arranged above, below, or to the side of the conveyor apparatus of the conveyor warewasher, and is designed to record at least one image of an area of the conveyor apparatus, preferably continuously or at times and/or events which are defined or can be defined in advance. In this design variant, it is preferred that an evaluation device is furthermore provided, which is designed to evaluate and determine whether there are areas without washware in the area of the conveyor apparatus at the time of image acquisition, and/or the load level of the conveyor apparatus.

According to a further aspect of the present invention, which can optionally be implemented in combination with the aforementioned embodiments, it is provided that the conveyor warewasher comprises a control device which is designed to determine a temporal development of the load of the conveyor apparatus with washware to be transported through the treatment zones of the conveyor warewasher; and/or to generate statistics on the load level of the conveyor apparatus.

In this context, it is particularly conceivable that the control device is designed to generate a corresponding notification and/or, in particular, an output to the operator of the conveyor warewasher, depending on the determined temporal development and/or statistics created. This notification preferably includes a recommendation for optimized operation of the conveyor warewasher, in particular with regard to cleaning efficiency.

Alternatively or in addition to this, it is conceivable that the conveyor warewasher comprises a control device which is designed to output a message, in particular an error or warning message, in particular to the washing personnel assigned to the conveyor warewasher and/or the operator of the conveyor warewasher, if it is determined by the device for detecting a load of the conveyor apparatus that an actual load level of the conveyor apparatus or an average load level of the conveyor apparatus as averaged over a time period which is, in particular, defined in advance or can be defined in advance is below a load level of the conveyor apparatus which is defined in advance or can be defined in advance.

In response to such a message, the washing personnel or operator of the conveyor warewasher can then initiate appropriate measures, such as reducing the transport speed of the conveyor apparatus.

The task underlying the invention is furthermore solved by a method of operating a conveyor warewasher, in particular a conveyor warewasher of the type according to the invention described above, or a conveyor warewasher according to the preamble of claim 1. In the method, in particular during an observation phase over an observation period, which preferably relates to a washing shift or washing day of the conveyor warewasher, a temporal development of the load level of the conveyor apparatus is determined by the device for detecting a load of the conveyor apparatus, and a pattern or regularity is preferably derived on the basis of the determined temporal development.

Alternatively or additionally, it is provided in the method according to the invention that, in particular during an observation phase over an observation period, which preferably relates to a washing shift or washing day of the conveyor warewasher, statistics on the development of the load level of the conveyor apparatus over time are generated.

According to further developments of the method according to the invention, it is, in particular, provided that a corresponding notification is generated and/or issued to the operator of the conveyor warewasher, in particular as a function of the determined temporal development and/or as a function of the generated statistics. Preferably, the notification contains a recommendation for operation of the conveyor warewasher that is, in particular, optimized with regard to cleaning efficiency.

Alternatively or additionally, it can be provided that an error or warning message is issued, in particular to the washing personnel assigned to the conveyor warewasher and/or the operator of the conveyor warewasher, if it is determined that the determined, in particular average, load level of the conveyor apparatus falls below a predefined or definable load level.

### BRIEF DESCRIPTION OF THE DRAWING

In the following, the invention will be described in further detail with reference to the accompanying drawing based on an exemplary embodiment of the conveyor warewasher according to the invention.

The following are shown:

FIG. 1 a schematic longitudinal sectional view of a conveyor warewasher according to an exemplary embodiment of the invention.

### DETAILED DESCRIPTION

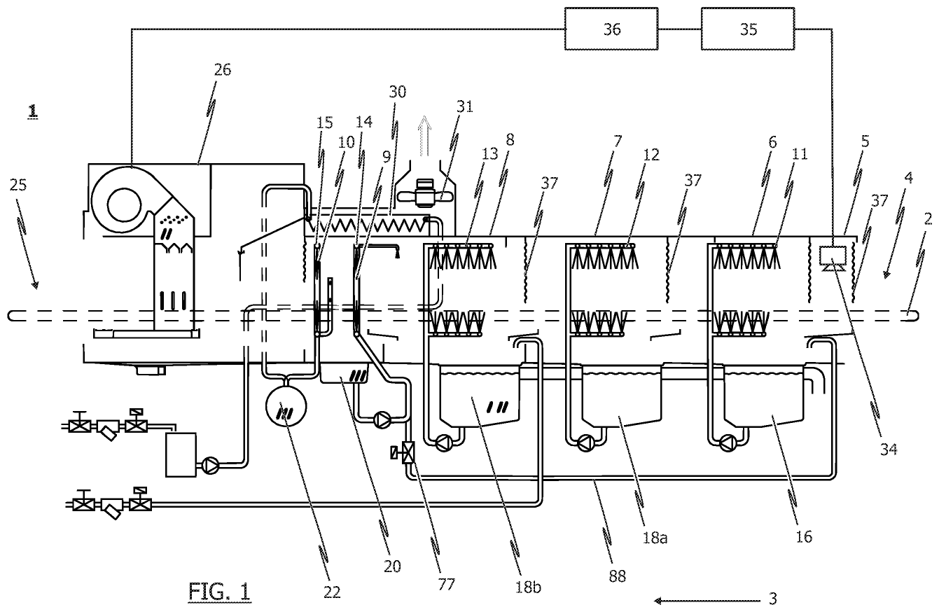

FIG. 1 shows a conveyor warewasher 1 with a conveyor apparatus 2 for conveying washware not shown in the drawings through the conveyor warewasher 1 in a direction of conveyance 3.

The conveyor apparatus 2 can be, for example, a conveyor belt, which is preferably designed as a multi-member plastic conveyor belt and is continuously driven by an electric drive not shown in FIG. 1, so that the washware placed upon the conveyor belt 2 is conveyed through the various treatment zones 6, 7, 8, 9, 10, and 26 of the conveyor warewasher 1 according to the illustration in FIG. 1.

Typically, the washware conveyed in the direction of conveyance 3 is placed upon the conveyor apparatus or conveyor belt 2 in the area of the inlet 4. According to the direction of conveyance 3 indicated by the arrow, the washware is then conveyed from the inlet 4 into an inlet tunnel 5.

The conveyor warewasher 1 according to the first embodiment of the present invention has at least one washing zone, for example as shown in FIG. 1, a pre-washing zone 6, as well as a first main washing zone 7 and a second main washing zone 8, which are arranged downstream of the pre-washing zone 6 when viewed in the direction of conveyance 3.

In the conveyor warewasher 1 shown in FIG. 1, a post-washing zone 9 and a rinsing zone 10 downstream of the post-washing zone 9 are arranged downstream of the at least one washing zone 6, 7, 8 when viewed in the direction of conveyance 3.

In the illustration according to FIG. 1, the conveyor apparatus 2 is shown as a circumferential conveyor belt. However, conveyor racks in which the not explicitly shown washware is inserted and which are placed on the top of the conveyor belt are also conceivable as the conveyor apparatus 2.

When viewed in the direction of conveyance 3, the washware received either directly on the conveyor belt 2 or held by racks runs in the direction of conveyance 3 through the inlet tunnel 5, the subsequent pre-washing zone 6, the first main washing zone 7, the second main washing zone 8, the post-washing zone 9, the rinsing zone 10, a drying zone 26, and into an outlet path 25.

Spray nozzles 11, 12, 13, 14, and 15 are respectively associated with the aforementioned treatment zones 6, 7, 8, 9, and 10 of the conveyor warewasher 1, via which nozzles liquid is sprayed onto the washware conveyed by the conveyor apparatus 2 through the respective treatment zones 6, 7, 8, 9, and 10. Each treatment zone 6, 7, 8, 9, and 10 is associated with a tank 16, 18, 20, and 22 in which sprayed liquid is received and/or in which liquid is provided for the spray nozzles of the respective zones. In the conveyor warewasher 1 shown in FIG. 1, rinsing liquid is sprayed onto the washware, not shown in the illustrations, in the form of fresh water, which may be pure or mixed with further additives such as rinsing agents, via the spray nozzles 15 of the rinsing zone 10 arranged above and below or to the side of the conveyor belt.

A portion of the sprayed rinsing liquid is conveyed from zone to zone in a cascading system counter to the direction of conveyance 3 of the washware. The remaining portion is guided directly into the pre-wash tank 16 via a valve 77 and a bypass line 88.

The sprayed rinsing liquid is collected in the tank 20 (post-wash tank 20) of the post-washing zone 9, from which it is conveyed via a pump system to the spray nozzles 14 (post-wash nozzles 14) of the post-washing zone 9. In the post-washing zone 9, washing liquid is rinsed from the washware. The liquid resulting from this flows into the wash tank 18b of the second main washing zone 8, is usually provided with a cleaning agent and then sprayed onto the washware by a pumping system via the nozzles 13 (wash nozzles 13) of the second main washing zone 8.

Liquid flows from the wash tank 18b of the second main washing zone 8 into the wash tank 18a of the first main washing zone 7. From there, the liquid is again sprayed onto the washware by a further pump system via the wash nozzles 12 of the first main washing zone 7. From the wash tank 18a of the first main washing zone 7, the liquid then flows into the pre-wash tank 16 of the pre-washing zone 6. Liquid in the pre-wash tank 16 is sprayed onto the washware by a pumping system via the pre-wash nozzles 11 of the pre-washing zone 6 in order to remove coarse impurities from the washware.

The individual rinsing systems of the treatment zones 6, 7, 8, 9, and 10 ensure that the washware is sprayed from both the top and the bottom.

The respective zones 6, 7, 8, 9, and 10 of the conveyor warewasher 1 can be separated from one another via separating curtains 37. In the embodiment shown in FIG. 1, the inlet tunnel 5 itself is also separated from the inlet 4 via a separating curtain 37. The provision of separating curtains 37 can prevent washing liquid and rinsing liquid from splashing out and steam from escaping from the conveyor warewasher.

The aforementioned drying zone 26 follows the rinsing zone 10 in the direction of conveyance 3 of the washware. In the drying zone 26, the washware is dried with dry and heated air in order to blow off or dry the moisture that is present on the washware. In order to maintain the moisture content of the air within a range that is favorable for drying, it is conceivable, for example, to supply room air via an opening, for example through the exit opening for the washware. The warm and moistened air is extracted from the drying zone 26, for example, by means of a fan 31 via a further opening.

It is advantageous for the exhaust air from the drying zone 26 to pass through a device for heat recovery 30, in which a condenser can be provided. The heat recovery device 30 serves to recover at least a portion of the heat energy contained in the exhaust air.

In today's belt/rack conveyor warewashers, the washware is conveyed through a plurality of treatment zones, such as pre-washing zones, main washing zones, post-washing zones, rinsing zones, and drying zones.

The conveyor warewasher 1 according to the invention as shown, for example, in FIG. 1 is characterized in that the conveyor warewasher 1 comprises a camera system 34, which is arranged above the conveyor apparatus 2 and is designed to take at least one image of an area of the conveyor apparatus 2, preferably continuously or at predetermined or determinable times and/or events.

The camera system 34 is associated with an image processing device 35, which is designed in order to, in particular, optionally pre-process the at least one image captured by the camera system 34, to segment the particularly optionally pre-processed image, extract features, and classify objects contained in the image (washware).

In the exemplary embodiment of the conveyor warewasher according to the invention as shown in FIG. 1, the camera system with its associated image processing device serves to detect a load of the conveyor apparatus. Specifically, the camera system is used to determine, preferably continuously or at predetermined times and/or events, a load of the conveyor apparatus with washware to be transported through the treatment zones of the conveyor warewasher.

For example, the camera system may be designed to sense the presence of empty areas in the conveyor apparatus.

Since efficient loading of the conveyor apparatus can help to conserve resources and save time in the operation of the conveyor warewasher, load detection of the conveyor apparatus is an important aspect of process optimization.

According to one embodiment of the conveyor warewasher as shown schematically in FIG. 1, it is provided that the aforementioned control device, which is connected with signal or data technology to the camera system or the image processing device that is associated with the camera system, is designed to determine, in particular during a learning or observation phase, over at least one observation period and preferably over a plurality of observation periods, a temporal development of the load of the conveyor apparatus with washware to be transported through the treatment zones of the conveyor warewasher. The observation period mentioned above is, for example, a washing shift or washing day of the conveyor warewasher, or a time period thereof.

Preferably, the control device is furthermore designed to “artificially” generate knowledge from the temporal development of the load of the conveyor apparatus as captured in the learning or observation phase. The control device learns from examples during the learning or observation phase, and can generalize them after the learning phase has been completed. To this end, algorithms of the control device in machine learning can build a statistical model based on training data, which is tested against the test data.

The control device of the conveyor warewasher is, in particular, designed to derive a pattern or regularity based on the determined temporal development of the load of the conveyor apparatus.

In one implementation of this aspect, it is provided that the control device divides the observation period, which preferably relates to a washing shift or washing day of the conveyor warewasher or a time period thereof, into a sub-period and at least one further, second sub-period, wherein, during the first sub-period of the observation period, the determined, in particular average, load level of the conveyor warewasher corresponds to a first relative value or falls within a first relative value range, and wherein, during the at least one second sub-period of the observation period, the determined, in particular average, load level of the conveyor apparatus corresponds to a first relative value or falls within a first relative value range, and wherein, during the at least one second sub-period of the observation period, the determined, in particular average load level of the conveyor apparatus corresponds to a second relative value or falls within a second relative value range.

For example, the first relative value of the in particular average load level of the conveyor apparatus corresponds to a remaining load capacity of the conveyor apparatus that is greater (or optionally smaller) than the remaining load capacity of the conveyor apparatus that corresponds to the second relative value of the in particular average load level of the conveyor apparatus.

In other words, the control device of the conveyor warewasher according to the invention is designed to detect, during the learning or observation phase, at which time periods/time points during a washing day or washing shift of the conveyor warewasher there is an efficient load of the conveyor apparatus, or during which time periods/time points of the washing shift or washing day the load of the conveyor apparatus/conveyor belt runs through the individual treatment zones of the conveyor apparatus with gaps or empty areas. On the basis of this knowledge, the control device is preferably designed to adjust the process parameters of the conveyor warewasher accordingly, preferably automatically and even more preferably optionally automatically, during the determined time periods which correspond, in a figurative sense, to the first subperiod or the at least one further, second subperiod of the observation period.

In particular, the control device is designed to initiate, preferably automatically after the end of the learning or observation phase and even more preferably optionally automatically during the operation of the conveyor warewasher in a washing shift or washing day, for the first subperiod, at least one first measure influencing the treatment of the washware in the treatment zones of the conveyor warewasher, and/or at least one measure influencing the quality of a washing liquid to be sprayed in the at least one washing zone of the conveyor warewasher; if necessary with a time delay; and, for the at least one further, second subperiod, to initiate at least one second measure influencing the quality of a washing liquid to be sprayed in the at least one washing zone of the conveyor warewasher, if necessary with a time delay, and for the at least one further, second subperiod, to initiate at least one second measure which influences the treatment of the washware in the treatment zones of the conveyor warewasher and/or at least one second measure which influences the quality of a washing liquid to be sprayed in the at least one washing zone of the conveyor warewasher, if necessary with a time delay.

For example, it is conceivable that the control device of the conveyor warewasher automatically decreases the transport speed of the conveyor apparatus for time periods/time points of the washing shift or washing day of the conveyor warewasher, for example, if the control device “knows” that during this period or at this time point, the conveyor apparatus is only partially loaded based on the test data recorded during the learning or observation phase.

As a further example, the control device can, in particular, also affect the quality of the washing liquid to be sprayed in the at least one washing zone if the control device “knows” that a particularly high load on the conveyor apparatus is to be expected over this period of time, which is to be equated with increased dirt being carried in. In general terms, the measure influencing the treatment of the washware in the treatment zones of the conveyor warewasher therefore consists of at least one of the measures listed below:
increasing or decreasing the temperature of the rinsing liquid to be sprayed in the at least one rinsing zone;
increasing or decreasing the pressure of the rinsing liquid to be sprayed in the at least one rinsing zone;
increasing or decreasing the amount of rinsing liquid sprayed per time unit in the at least one rinsing zone;
increasing or decreasing the temperature of the washing liquid to be sprayed in the at least one washing zone;
increasing or decreasing the pressure of the washing liquid to be sprayed in the at least one washing zone;
increasing or decreasing the amount of washing liquid sprayed per time unit in the at least one washing zone; and/or
increasing or decreasing the conveying speed of the conveyor apparatus.

In particular, it is conceivable, for example, that the control device automatically and preferably optionally automatically reduces the transport speed of the conveyor apparatus for time periods during the washing shift or washing day of the conveyor warewasher if the control device assumes, on the basis of test data determined during the learning or observation phase, that only a low load, i.e., a low load level, of the conveyor apparatus is to be expected during this time period. With the reduced transport speed, the contact time of the washware that is transported through the treatment zones of the conveyor warewasher by the conveyor apparatus increases, so that the mechanics and/or temperature of the liquid sprayed in the treatment zones can also be reduced simultaneously, which positively influences the energy efficiency of the machine.

With regard to the measure influencing the quality of the washing liquid to be sprayed in the at least one washing zone of the conveyor warewasher, at least one of the measures listed below is conceivable:
Increasing or decreasing a regeneration of the washing liquid to be sprayed in the at least one washing zone of the conveyor warewasher;
Increasing or decreasing a dirt-carrying capacity of the washing liquid to be sprayed in the at least one washing zone; and/or
Activating or deactivating a dirt discharge from the washing liquid to be sprayed in the at least one washing zone.

Regeneration of the washing liquid to be sprayed in the at least one washing zone of the conveyor warewasher can be increased or decreased by varying the amount of water per time unit that flows into the washing tank of the washing zone, mostly from the fresh water clear rinse upstream in the transport direction of the conveyor apparatus.

Dirt-carrying capacity of the washing liquid refers to the ability of the washing liquid to disperse or emulsify food residues in a manner that prevents them from settling down again on the surfaces of already cleaned washware. The dirt-carrying capacity can, in particular, be influenced by the concentration of the chemical cleaning agent in the washing liquid.

On the other hand, the dirt load of the washing liquid affects the cleaning result as well as foam formation. The dirt load of the washing liquid is the total of all dirt components, regardless of whether they are easily or poorly soluble, emulsifying, and/or dispersible contaminants of the washing liquid. In order to reduce the dirt load of the washing liquid, it is conceivable to activate a dirt discharge from the washing liquid to be sprayed in the washing zone.

For this purpose, it is conceivable, for example, that the at least one washing zone comprises a washing system that is designed as a recirculation circuit, wherein the washing system comprises a nozzle system with at least one washing nozzle for spraying washing liquid onto the washware, a washing tank for collecting at least part of the sprayed washing liquid, and a washing pump for supplying washing liquid that is collected in the washing tank to the at least one washing nozzle.

Furthermore, a washing discharge system (not shown in FIG. 1) that is associated with the at least one washing system is provided. The dirt discharge system, which is not explicitly shown in the drawing, features a tank cover screen that is designed to separate dirt particles from the sprayed washing liquid flowing back into the washing tank by gravity. The dirt discharge system preferably furthermore comprises a dirt collection area that is arranged at least partly within the washing tank, and serves to collect dirt particles separated from the washing liquid by means of the tank cover screen.

Within this context, it is particularly conceivable that a dirt discharge system is provided, which has a fluid connection to the dirt collection area, and via which the dirt collection area can be emptied; in particular, as needed.

In one implementation of the conveyor warewasher according to the invention, the control device can be designed to activate and/or deactivate the dirt discharge system and, in particular, a dirt discharge pump that is assigned to the dirt discharge system, preferably automatically and, even more preferably, optionally automatically as a function of the determined, in particular average, load level of the conveyor apparatus and, if necessary, with a time delay, in order to reduce the dirt load in the washing liquid.

As indicated in FIG. 1, the device for detecting a load of the conveyor apparatus of the conveyor warewasher comprises a camera system which is arranged above, below, or to the side of the conveyor apparatus, and is designed to record at least one image of an area of the conveyor apparatus, preferably continuously or at times and/or events that are or can be defined in advance. Furthermore, the aforementioned evaluation device is provided, which is designed to evaluate and determine whether there are areas without washware in the area of the conveyor apparatus at the time at which the image is recorded, and/or the load level of the conveyor apparatus.

The conveyor warewasher according to the invention, which is shown schematically in FIG. 1, does not necessarily have to be designed to derive a pattern or regularity from the temporal development of the load of the conveyor apparatus via machine learning during a learning or observation phase.

In principle, it is also conceivable that the control device of the conveyor warewasher is designed to output a message, in particular an error or warning message, in particular to the washing personnel assigned to the conveyor warewasher and/or the operator of the conveyor warewasher, if it is determined by the device for detecting a load of the conveyor apparatus that an actual load level of the conveyor apparatus or an average load level of the conveyor apparatus—as averaged over a time period that is, in particular, defined in advance or can be defined in advance—is below a load level of the conveyor apparatus that is defined in advance or can be defined in advance.

Alternatively or in addition to this, the control device can be designed to determine a temporal development of the load of the conveyor apparatus with washware to be transported through the treatment zones of the conveyor warewasher, and/or generate statistics on the load level of the conveyor apparatus.

The determined temporal development of the load of the conveyor apparatus and/or the statistics on the load level of the conveyor apparatus can serve as status-based monitoring. This information can additionally be used for the purpose of “predictive maintenance”. This makes it possible to gain additional knowledge regarding the operation of the conveyor warewasher, so that maintenance can be better planned without impeding the operation of the conveyor warewasher during a washing shift or washing day.

Accordingly, the invention also relates in particular to a method of operating a conveyor warewasher, in particular a conveyor warewasher as shown schematically in FIG. 1. In the method, it is conceivable that, in particular during an observation phase over an observation period which preferably relates to a washing shift or washing day of the conveyor warewasher, a temporal development of the load level of the conveyor apparatus as determined by the device for detecting a load of the conveyor apparatus is determined, and a pattern or regularity is derived on the basis of the determined temporal development.

Alternatively or additionally, it is conceivable that during an observation phase over an observation period preferably relating to a washing shift or washing day of the conveyor warewasher, statistics are generated regarding the time points of the load levels on the conveyor apparatus.

Depending on the determined temporal development and/or the generated statistics, a corresponding message can be generated and, in particular, issued to the operator of the conveyor warewasher, wherein the message preferably contains a recommendation for optimized operation of the conveyor warewasher, in particular with regard to cleaning efficiency.

It is furthermore conceivable that an error or warning message is output in particular to the washing personnel assigned to the conveyor warewasher and/or the operator of the conveyor warewasher when it is determined that the determined and, in particular, average load level of the conveyor apparatus falls below a pre-determined or determinable load level.

The invention is not limited to the conveyor warewasher shown in FIG. 1, but results from a summary of all features disclosed herein.

1. A conveyor warewasher for cleaning washware, wherein the conveyor warewasher comprises at least one washing zone and at least one rinsing zone and a conveyor apparatus for conveying washware through the at least one washing zone and the at least one rinsing zone, wherein the conveyor warewasher comprises a device for sensing a loading of the conveyor apparatus, which device is configured in order to determine a loading of the conveyor apparatus with the washware to be conveyed through the treatment zones of the conveyor warewasher,
characterized in that
the conveyor warewasher comprises a control device, which is configured in order to, during a learning or observation phase over at least one observation period or over a plurality of observation periods each relating to a washing shift or a washing day of the conveyor warewasher or a portion thereof, determine a chronological profile of the loading of the conveyor apparatus with washware to be conveyed through the treatment zones of the conveyor warewasher, wherein the control device is further configured in order to deduce a pattern or a regularity based on the determined chronological profile of the loading of the conveyor apparatus with washware.

2. The conveyor warewasher according to claim 1,
wherein the control device is further configured in order to divide the observation period relating to a washing shift or a washing day of the conveyor warewasher or a portion thereof into a first sub-period and into at least one further second sub-period, wherein, in the first sub-period of the observation period, the determined average loading level of the conveyor apparatus with the washware corresponds to a first relative value or falls within a first relative value range, and wherein, in the at least one second sub-period of the observation period, the determined average loading level of the conveyor apparatus with the washware corresponds to a second relative value or falls within a second relative value range.

3. The conveyor warewasher according to claim 2,
wherein the first relative value of the average loading level of the conveyor apparatus corresponds to a remaining load capacity of the conveyor apparatus that is greater than the remaining loading capacity of the conveyor apparatus corresponding to the second relative value of the average loading level of the conveyor apparatus.

4. The conveyor warewasher according to claim 2,
wherein the control device is further configured in order to initiate, for the first sub-period, after the end of the learning or observation phase, at least one first measure influencing the treatment of the washware in the treatment zones of the conveyor warewasher and/or at least one measure influencing the quality of a washing liquid to be sprayed in the at least one washing zone of the conveyor warewasher and to initiate, for the at least one second sub-period, at least one second measure influencing the treatment of the washware in the treatment zones of the conveyor warewasher and/or at least a second measure influencing the quality of a washing liquid to be sprayed in the at least one washing zone of the conveyor warewasher.

5. The conveyor warewasher according to claim 4,
wherein the measure influencing the treatment of the washware in the treatment zones of the conveyor warewasher is at least one of the measures listed below:
increasing or decreasing the temperature of the rinsing liquid to be sprayed in the at least one rinsing zone; and/or
increasing or decreasing the pressure of the rinsing liquid to be sprayed in the at least one rinsing zone; and/or
increasing or decreasing the amount of rinsing liquid sprayed per unit of time in the at least one rinsing zone; and/or
increasing or decreasing the temperature of the washing liquid to be sprayed in the at least one washing zone; and/or
increasing or decreasing the pressure of the washing liquid to be sprayed in the at least one washing zone; and/or
increasing or decreasing the amount of washing liquid sprayed per unit time in the at least one washing zone; and/or
increasing or decreasing the pressure of drying air to be sprayed in an optional drying zone; and/or
increasing or decreasing the temperature of drying air to be sprayed in an optional drying zone; and/or
increasing or decreasing the amount of drying air sprayed per unit time in an optional drying zone; and/or
increasing or decreasing the conveying speed of the conveyor apparatus.

6. The conveyor warewasher (1) according to claim 4,
wherein the measure influencing the quality of the washing liquid to be sprayed in the at least one washing zone of the conveyor warewasher is at least one of the measures listed below:
increasing or decreasing a regeneration of the washing liquid to be sprayed in the at least one washing zone of the conveyor warewasher;
increasing or decreasing a dirt-carrying capacity of the washing liquid to be sprayed in the at least one washing zone; and/or
activating or deactivating a dirt discharge from the washing liquid to be sprayed in the at least one washing zone.

7. The conveyor warewasher according to claim 6,
wherein the at least one washing zone comprises a washing system configured as a recirculation circuit, wherein the washing system comprises a nozzle system having at least one washing nozzle for spraying washing liquid onto the washware to be cleaned, a wash tank for collecting at least a portion of the sprayed washing liquid, and a wash pump for supplying washing liquid collected in the wash tank to the at least one wash nozzle, and wherein a soil discharge system associated with the at least one washing system is further provided, wherein a tank cover screen is associated with the soil discharge system, which screen is configured in order to separate soil particles from the washing liquid that is sprayed and flows back into the wash tank due to gravity, wherein the soil discharge system comprises a soil collection region arranged at least regionally in the wash tank for collecting the soil particles separated from the washing liquid by means of the tank cover screen, and wherein a soil discharge system fluidly connected to the soil collection region is further provided, via which system the soil collection region can be emptied, in particular as needed, wherein the control device is configured in order to activate and/or deactivate a soil discharge pump associated with the soil discharge system, automatically depending on the determined average loading level of the conveyor apparatus, if necessary at a delay.

8. The conveyor warewasher according to claim 1,
wherein the device for sensing a loading of the conveyor apparatus comprises a camera system, which is arranged above or below or to the side of the conveyor apparatus and is configured in order to capture at least one image of a region of the conveyor apparatus continuously or at predetermined or determinable times and/or events, wherein an evaluation device is further provided, which is configured in order to evaluate and determine whether, at the time of the image capture, washware-free regions are present in the region of the conveyor apparatus, and/or what the loading level of the conveyor apparatus is.

9. The conveyor warewasher according to claim 1,
characterized in that
the conveyor warewasher comprises a control device, which is configured in order to output a notification to the washing personnel assigned to the conveyor warewasher and/or to the operator of the conveyor warewasher, when it is determined by the device for sensing a loading of the conveyor apparatus that a current or average loading level of the conveyor apparatus is above or below a predetermined or determinable loading level of the conveyor apparatus.

10. The conveyor warewasher according to claim 1,
characterized in that
the conveyor warewasher comprises a control device, which is configured in order to determine a chronological profile of the loading of the conveyor apparatus with washware to be conveyed through the treatment zones of the conveyor warewasher and/or to create statistics about the loading level of the conveyor apparatus.

11. The conveyor warewasher according to claim 10,
wherein the control device is further configured in order to generate a corresponding notification and/or output it to the operator of the conveyor warewasher depending on the determined chronological profile and/or the statistics created, wherein the notification contains a recommendation for optimized operation of the conveyor warewasher with regard to the cleaning efficiency.

12. A method for operating a conveyor warewasher, wherein the method comprises the following method steps:
during an observation phase over an observation period relating to a washing shift or a washing day of the conveyor warewasher, a chronological profile of a loading level of the conveyor apparatus determined by the device for sensing a loading of the conveyor apparatus is determined and, based on the determined chronological profile, a pattern or regularity is derived; and/or
during an observation phase over an observation period relating to a washing shift or a washing day of the conveyor warewasher, statistics are created regarding the chronological profile of the loading level of the conveyor apparatus.

13. The method according to claim 12,
wherein a corresponding notification is generated and/or output to the operator of the conveyor warewasher depending on the determined chronological profile and/or the statistics created, wherein the notification contains a recommendation for optimized operation of the conveyor warewasher with regard to the cleaning efficiency.

14. The method according to claim 12,
wherein an error or warning message is output to the washing personnel assigned to the conveyor warewasher and/or the operator of the conveyor warewasher when it is determined that the determined average loading level of the conveyor apparatus falls below a pre-determined or determinable loading level.
